(19) United States
(12) Patent Application Publication
(10) Pub. No.: US 2021/0358274 A1
(43) Pub. Date: Nov. 18, 2021

(54) COOPERATIVE CARD WAGERING GAME AND DUAL-HAND VARIANT

(71) Applicant: Matthew Weiss, New York, NY (US)

(72) Inventor: Matthew Weiss, New York, NY (US)

(21) Appl. No.: 17/386,102

(22) Filed: Jul. 27, 2021

Related U.S. Application Data
(63) Continuation-in-part of application No. 17/198,571, filed on Mar. 11, 2021.
Application No. 17/198,571 is a continuation of application No. 16/856,352, filed on Apr. 23, 2020, now Pat. No. 11,043,080.

(51) Int. Cl. G07F 17/32

(52) U.S. Cl. CPC G07F 17/3293; G07F 17/3267; G07F 17/3223

(57) ABSTRACT

A method for playing a dual-hand card wagering game with a player and a dealer using a wagering table and a deck of cards with each card having a numerical value, the player is dealt cards to form a primary hand, and transfers a card from the primary hand to form a secondary hand, while the dealer retains cards to form a dealer hand. The total numerical values of the primary hand and the secondary hand are compared to the dealer hand to determine a primary result and a secondary result corresponding to a primary or secondary loss, tie, or win. The primary and secondary results are considered in combination to determine a game result corresponding to a player win, player push, or player loss. The dual-hand card wagering game may also be played electronically using a dual-hand card game system.

### CROSS-REFERENCE TO RELATED APPLICATIONS

This application is a continuation in part of U.S. patent application Ser. No. 17/198,571 filed in the United States Patent Office on Mar. 11, 2021, which is a continuation of U.S. patent application Ser. No. 16/856,352 filed in the United States Patent Office on Apr. 23, 2020. This application claims priority to the aforementioned applications, which are expressly incorporated herein by reference in their entirety.

### TECHNICAL FIELD

The present disclosure relates generally to a card wagering game played using a novel physical apparatus. More particularly, the present disclosure relates to a card wagering game played with two hands per player using a custom cooperative wagering table, or in electronic form via a game system.

### BACKGROUND

In conventional casino card wagering games, each player plays a single hand, either against other players or against a dealer. Ideally, such a game will reward strategic play and skillful analysis of risks and rewards, while remaining accessible through fast pacing and uncomplicated rules. It is possible to greatly increase strategic depth without encumbering gameplay or hampering accessibility by introducing a card wagering game where each player simultaneously plays two hands against a dealer, and must allocate cards between the two hands to maximize the chances of victory.

In the present disclosure, where a document, act or item of knowledge is referred to or discussed, this reference or discussion is not an admission that the document, act or item of knowledge or any combination thereof was at the priority date, publicly available, known to the public, part of common general knowledge or otherwise constitutes prior art under the applicable statutory provisions, or is known to be relevant to an attempt to solve any problem with which the present disclosure is concerned.

While certain aspects of conventional technologies have been discussed to facilitate the present disclosure, no technical aspects are disclaimed and it is contemplated that the claims may encompass one or more of the conventional technical aspects discussed herein.

### BRIEF SUMMARY

An aspect of an example embodiment in the present disclosure is a card wagering game where a player competes against a dealer using two hands of cards. Accordingly, the present disclosure provides a method for playing a dual-hand card wagering game using a card deck, where each card in the deck has a corresponding numerical value. The player is dealt a plurality of cards forming a primary hand, while the dealer is dealt a dealer's hand. The player selects a card from the primary hand and transfers the selected card to form a secondary hand, whereby the goal is to maximize the total numerical value of the secondary hand, as well as the total numerical value of the cards retained in the primary hand. The total numerical values of the primary and secondary hands are compared against the dealer's hand to determine a primary result and a secondary result respectively. The primary and secondary result may correspond to a primary or secondary loss, a primary or secondary tie, or a primary or secondary win. The primary result and the secondary result are considered in combination to determine a game result corresponding to a player win, a player push (tie), or a player loss. In one embodiment, the player can achieve the player win game result if the primary result is a primary win and the secondary result is not a secondary loss, or if the primary result is not a primary loss and the secondary result is a secondary win. Other combinations of the primary or secondary results will determine whether the player achieves the player push or player loss game results. For example, the player may avoid the player loss game result upon obtaining a primary tie and a secondary tie, or upon obtaining a primary win and a secondary loss or vice versa.

It is another aspect of an example embodiment in the present disclosure to provide a dual-hand card wagering game which is played using a custom table. Accordingly, the present disclosure provides a custom wagering table comprising a playing surface with a player table edge, a dealer table edge, and a dividing line positioned therebetween. The dividing line divides the playing surface between a dealer area and a player area. The primary hands of the player are dealt directly to the player area, while the dealer's hand is placed in the dealer's area proximate to the dealer's table edge. The card forming the secondary hand is placed on the playing surface in contact with the dividing line, thus clearly distinguishing the secondary hand from the primary hand and the dealer's hand.

It is yet another aspect of an example embodiment in the present disclosure to provide a dual-hand card wagering game which can be played electronically. Accordingly, the present disclosure provides a dual-hand card game system comprising a user game device operably connected to a game control server, which can be played remotely over a data communication network as well as within a gaming venue. The dual-hand card game system executes a card game application which replicates the dual-hand card wagering game, and provides a dual-hand game interface adapted to allow the player to transfer a card from the primary hand to the secondary hand.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

### BRIEF DESCRIPTION OF THE DRAWINGS

In the drawings, like elements are depicted by like reference numerals. The drawings are briefly described as follows.

FIG. 1 is a diagrammatical top view of a cooperative card wagering game being played by a plurality of players and a dealer using a cooperative wagering table, the cooperative wagering table having a playing surface divided between a dealer area and a community area by a community line, in accordance with an embodiment in the present disclosure.

FIG. 2A is a diagrammatical top view of the cooperative card wagering game in progress, with each player contributing a card to form a community hand, whereby the cards of the community hand are placed in contact with the community line, in accordance with an embodiment in the present disclosure.

FIG. 2B is a diagrammatical top view of a portion of the playing surface depicting a variant of the community line, in accordance with an embodiment in the present disclosure.

FIG. 2C is a diagrammatical top view of a portion of the playing surface, depicting community cards placed in the dealer area proximate to the community line, in accordance with an embodiment in the present disclosure.

FIG. 3 is a diagrammatical top view depicting the cooperative card wagering game in progress, where the cards of the dealer's hand have been revealed in response to the completion of the community hand, in accordance with an embodiment in the present disclosure.

FIG. 4 is a diagrammatical top view of another cooperative card wagering game in progress, where an additional dealer card has been drawn and added to the dealer's hand, in accordance with an embodiment in the present disclosure.

FIG. 5 is a flowchart depicting an exemplary cooperative card wagering game process, in accordance with an embodiment in the present disclosure.

FIG. 6A is a table depicting combinations of individual hand results and community hand results which produce the player win, player push, and player loss game results, in accordance with an embodiment in the present disclosure.

FIG. 6B is a table depicting draw thresholds in relation to the quantity of players participating in the cooperative card wagering game, in accordance with an embodiment in the present disclosure.

FIG. 7A is a block diagram depicting an exemplary cooperative card game system for playing the cooperative card game electronically over a digital communication network, in accordance with an embodiment in the present disclosure.

FIG. 7B is a block diagram depicting an exemplary cooperative card game system for playing the cooperative card wagering game within a gaming venue, in accordance with an embodiment in the present disclosure.

FIG. 7C is a diagrammatical front view of an exemplary user game device with an output screen, which is configured to execute a multiplayer card game application in accordance with an embodiment in the present disclosure.

FIG. 7D is a diagrammatical top view of an electronic cooperative wagering table with integral output screens for playing the cooperative card wagering game, in accordance with an embodiment in the present disclosure.

FIG. 7E is a block diagram depicting an exemplary dual-hand card game system for playing a dual-hand card wagering game electronically over a digital communication network, in accordance with an embodiment in the present disclosure.

FIG. 8 is a block diagram depicting an example architecture of the user game device, in accordance with an embodiment in the present disclosure.

FIG. 9A is a block diagram showing an exemplary wagering interface, in accordance with an embodiment in the present disclosure.

FIG. 9B is a block diagram showing an exemplary cooperative gaming interface, in accordance with an embodiment in the present disclosure.

FIG. 9C is a block diagram showing an exemplary result interface, in accordance with an embodiment in the present disclosure.

FIG. 10 is a diagrammatical top view of an exemplary card wagering table for playing the dual-hand card wagering game, in accordance with an embodiment in the present disclosure.

FIG. 11 is a diagrammatical top view of an example dual-hand card wagering game in progress, showing a primary hand, a secondary hand, and the dealer's hand, in accordance with an embodiment in the present disclosure.

FIG. 12 is a table depicting combinations of primary results and secondary results which produce a player win, player push, and player loss game results, in accordance with an embodiment in the present disclosure.

FIG. 13A is a block diagram showing an exemplary dual-hand game interface by which the dual-hand card wagering game is played electronically, in accordance with an embodiment in the present disclosure.

FIG. 13B is a block diagram showing the player transferring a card from the primary hand to the secondary hand using the dual-hand game interface, in accordance with an embodiment in the present disclosure.

FIG. 13C is a block diagram showing the dealer's hand being revealed, to determine the secondary result, the primary result, and the game result, in accordance with an embodiment in the present disclosure.

FIG. 14 is a flowchart depicting an exemplary dual-hand card wagering game process, in accordance with an embodiment in the present disclosure.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete and fully conveys the scope of the present disclosure to those skilled in the art.

### DETAILED DESCRIPTION OF THE PREFERRED EMBODIMENTS

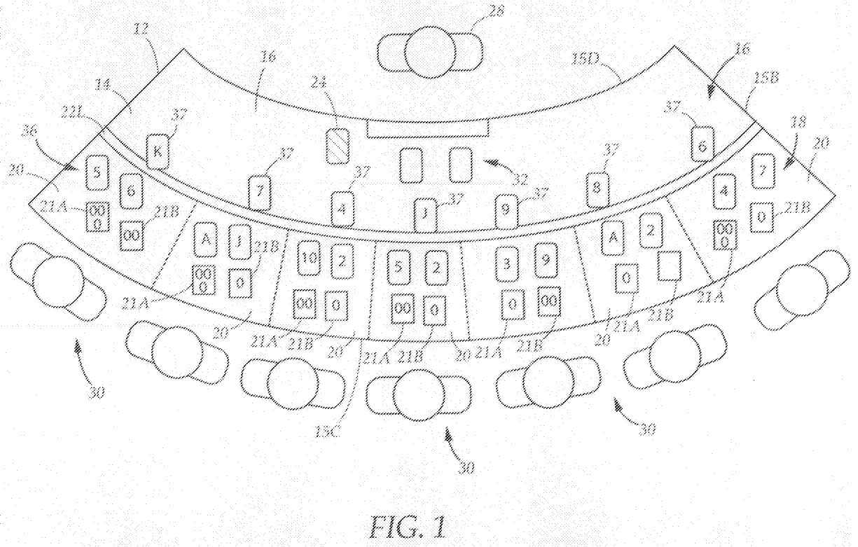

FIG. 1 illustrates a cooperative card wagering game, played by a plurality of players 30 and a dealer 28, using a card deck 24. In a preferred embodiment, the card deck 24 represents a conventional deck of playing cards comprising fifty-two cards, and up to seven players 30 may participate simultaneously. Each of the cards corresponds to a face card, a number card, or an ace, and has a numerical value from a range of zero to ten. Each face card has a numerical value of zero, while each number card has a numerical value of between two and ten. Each ace card has a numerical value of one.

In one embodiment, the cooperative card wagering game is played using a custom cooperative wagering table 12. The cooperative wagering table 12 has a substantially planar playing surface 14 upon which the cards are placed. The playing surface 14 has a dealer table edge 15D and a community table edge 15C. The playing surface 14 further has a community line 22L, which is positioned between the community table edge 15C and the dealer table edge 15D. In certain embodiments, the playing surface 14 further has a first end 15A and a distally oriented second end 15B which extend between the community and dealer table edges 15C, 15D. The community line 22L defines a dealer area 16 between the dealer table edge 15D and the community line 22L, and defines a community area 18 between the community table edge 15C and the community line 22L. The players 30 are positioned along the community table edge 15C, while the dealer 28 is positioned along the dealer table edge 15D. The community area 18 may be further divided between a plurality of player areas 20 for each of the players 30. The playing surface 14 further has one or more wagering areas 21A, which allow wagers to be placed thereon, as well as one or more side wager areas 21B. The side wager areas 21B allow side bets and side wagers to be placed thereon by each player 30. The wagering areas 21A and side wager areas 21B may be positioned within either the dealer area 16 or the community area 18. In certain embodiments, each player area 20 may contain a separate wagering area 21A and side wager area 21B, for use by the player 30 associated with the player area 20. The playing surface 14 may be rectangular, circular, elliptical, arcuate, or any shape that allows the player areas 20 to be evenly spaced along the community table edge 15C, while also allowing the dealer 28 to access the player areas 20 to deal and retrieve cards. In certain embodiments, the player areas 20 are marked off or otherwise delineated by borders between adjacent player areas 20.

In one embodiment in which the playing surface has an arcuate shape, the dealer table edge 15D and the community table edge 15C each have a length, and the length of the dealer table edge 15D is shorter than the length of the community table edge 15C. The dealer table edge 15D has a concave configuration, whereas the community table edge 15C has a convex configuration. The players 30 positioned along the community table edge 15C face inwardly towards the dealer table edge 15D and the dealer 28. The community line 22L, is positioned between and substantially parallel with the dealer and community table edges 15D, 15C, is likewise arcuate in shape. The arcuate shape of the playing surface 14 and the community line 22L provides each player 30 positioned along the community table edge 15C with an unobstructed view of any portion of the community line 22L. For example, a player 30 positioned by the first end 15A of the playing surface 14 is provided an unobstructed view of the entire community line 22L from the first end 15A to the second end 15B, thanks to the arcuate and convex configuration of the community line 22L and the community table edge 15C.

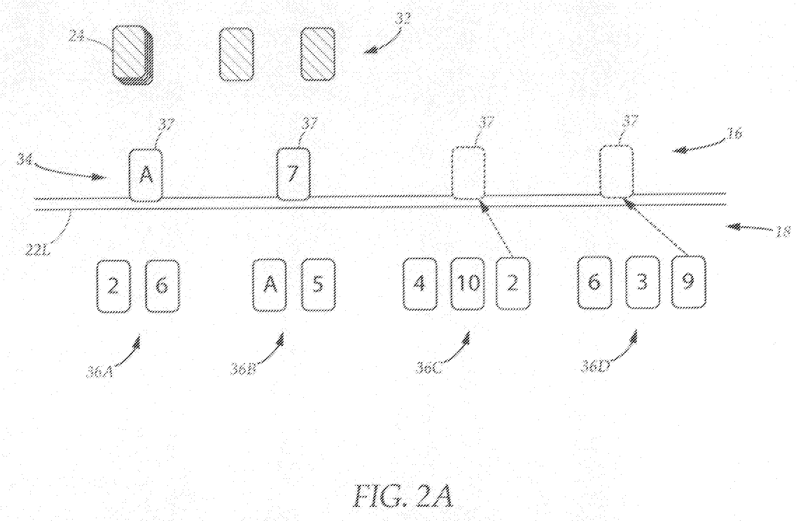

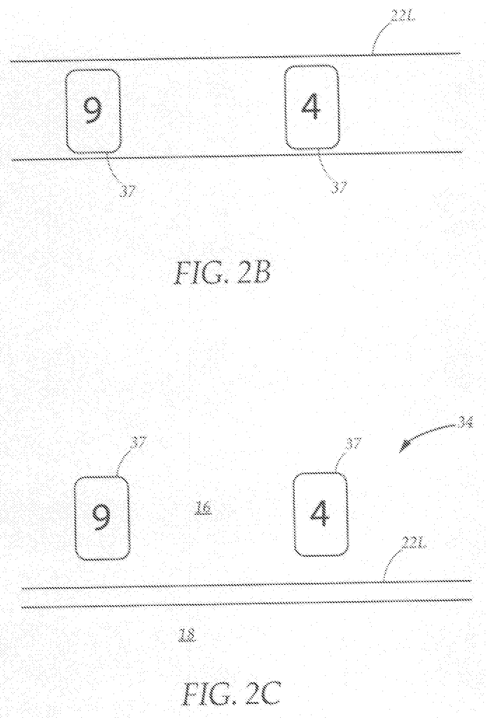

At the start of the cooperative wagering game, each player 30 places a wager. The wager corresponds to an amount of currency or game points, and may be represented using chips, tokens, or other suitable markers. Each player 30 may therefore place a wager directly within the wagering area 21A. Turning to FIG. 2A while continuing to refer to FIG. 1, the cooperative card wagering game requires the players 30 to compete against the dealer 28 both individually and cooperatively as a community. In a preferred embodiment, the players 30 cannot achieve a successful game result if the dealer 28 prevails against the community. Cooperation between the players 30 forms a vital strategic element of the cooperative card wagering game.

Each player 30 is dealt an individual hand 36 comprising three cards drawn from the deck 24 by the dealer 28, while the dealer 28 draws a dealer's hand 32 initially comprising two cards from the deck 24. Each card within the deck 24 has a first surface which indicates the identity of the card and its numerical value, and a distally oriented second surface. In a preferred embodiment, the cards of the dealer's hand 32 are dealt with the second surface of the card hidden from view, such as by placing the first surface of each card in contact with the playing surface 14, thus obscuring the numerical value of the dealer's hand 32. Conversely, in a preferred embodiment, the cards for each individual hand 36 are dealt with the first surface of each card exposed, thus revealing the numerical value of each individual hand 36 to all the players 30. The cards may be dealt to each of the players 30 according to a dealing order. Any dealing order commonly employed in card-based games may be utilized for the cooperative card wagering game. For example, the dealing order may involve each player 30 being dealt one card in a sequence from the dealer's left to the dealer's right or vice versa, along the community table edge 15C, until the individual hand 36 of each player 30 contains three cards.

Each player 30 must select one of the cards from said player's individual hand 36 to be a community card 37, and then contribute the community card 37 to form a community hand 34. As such, the quantity of the community cards 37 within the community hand 34 is equal to the quantity of participating players 30. The contributions to the community hand 34 may follow a sequence which mirrors the dealing order. In a preferred embodiment, each player 30 takes their selected community card 37 and places the card 37 upon the playing surface 14 in contact with the community line 22L, while the remaining two cards constituting the individual hand 36 remain within the community area 18, or within the player area 20 where appropriate. The community line 22L is used to guide the placement of the community cards 37 by the player 30 to ensure that each player 30 has an unobstructed view of the community cards 37. Furthermore, the community line 22L clearly distinguishes the community cards 37 which make up the community hand 34, from the cards remaining in the individual hands 36 of each player 30. In other embodiments, each community card 37 may be positioned in contact with the community line 22L such that the community card 37 rests within the dealer area 16 but not the community area 18. In certain embodiments (as shown in FIG. 2B), the community line 22L is sufficiently wide to accommodate the community cards 37 so that the community cards 37 rest upon the community line 22L without contacting either the dealer area 16 or the community area 18. Alternatively, as shown in FIG. 2C, the community card 37 may be positioned entirely within the dealer area 16 while remaining proximate to the community line 22L. Referring to FIG. 2C as well as FIG. 1, the cards of the community hand 34 may be distinguished from those of the dealer's hand 32 by positioning the community hand 34 closer in relation to the community line 22L, than to the dealer table edge.

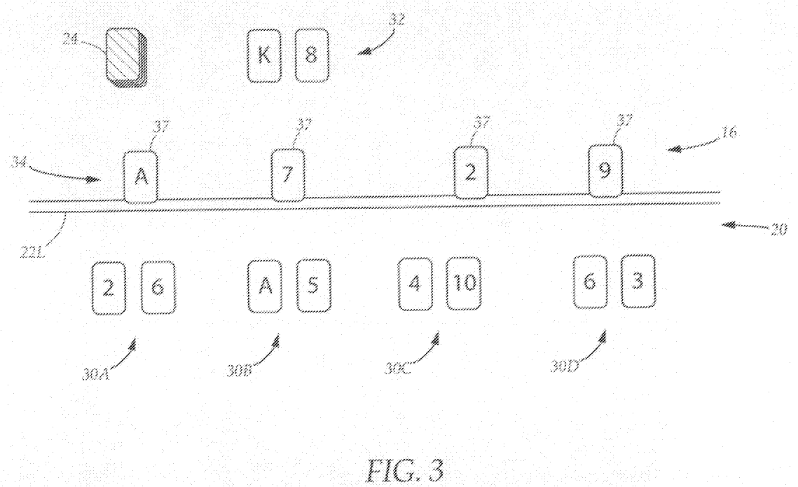

Returning to FIG. 1 and FIG. 3, when each player 30 selects a community card 37 for contribution to the community hand 34, the object is to ensure that the numerical value of the community hand 34 exceeds the numerical value of the dealer's hand 32, and that the numerical value of the player's individual hand 36 equals or exceeds the numerical value of the dealer's hand 32. The total numerical value of the relevant hand is determined by adding together the numerical values of the cards within the dealer's hand 32, community hand 34, or individual hand 36 as appropriate, and retaining only the rightmost digit of the resulting numerical value. For example, a hand containing two numerical cards each with the numerical value of nine, has a total numerical value of eight. Although the sum of nine and nine totals eighteen, only the rightmost digit is used for the total numerical value. As the numerical value of the dealer's hand 32 is hidden from the players 30, coordination and cooperation between the players 30 greatly increases the chance that the total numerical value of the community hand 34 will exceed the total numerical value of the dealer's hand 32. In certain embodiments, the players 30 are given a chance to discuss the selection of the community cards which will form the community hand 34, which may be limited in duration via a time limit.

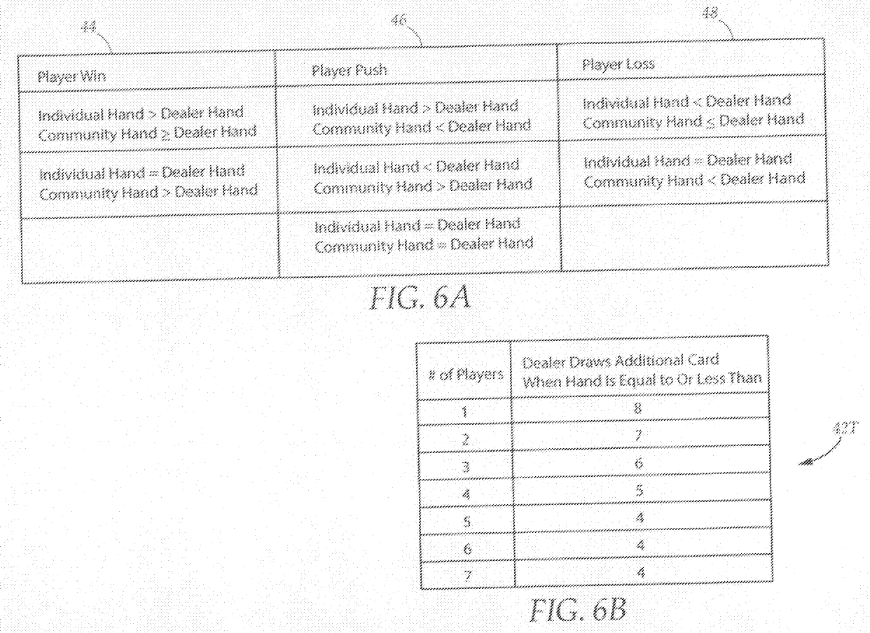

Once the community hand 34 is complete, the dealer's hand 32 is revealed. First, the community hand 34 is compared to the dealer's hand 32 to determine a community result. The community result may either be a community win, a community tie, or a community loss, depending on whether the total numerical value of the community hand 34 is greater than, equal to, or less than the total numerical value of the dealer's hand 32. Next, an individual result is determined for each player 30 by comparing the numerical value of the player's individual hand 36 with the numerical value of the dealer's hand 32, resulting in either an individual win, an individual tie, or an individual loss. Turning to FIG. 6A, while also referring to FIG. 1 and FIG. 3, a game result for each player 30 is determined, based on both the community result and the individual result for the player 30. In a preferred embodiment, the game result corresponds to either a player win 44, a player push 46, or a player loss 48. If the game result is a player win 44, the player 30 is awarded a certain amount of currency or points. If the game result is a player push 46, the wager is returned to the player 30. If the game result is a player loss 48, the player's wager is forfeited. For example, the dealer's hand 32 may have a total numerical value of eight, while the community hand 34 may include an ace, a “seven”, a “two”, and a “nine”, resulting in a total numerical value of nine. The community result is therefore a community win. Individual hand “A” 30A may include a “two” and a “six”, resulting in a total numerical value of eight, resulting in an individual loss. The player 30 holding individual hand “A” therefore achieves a game result of a player push 46.

In order for a player 30 to achieve the player win 44 game result, the individual result and community result must correspond to either: an individual win and a community win or community tie; or an individual tie and a community win. The player 30 will achieve the player push 46 game result if the individual result and the community result correspond to: an individual win and a community loss; an individual loss and a community win; or an individual tie and a community tie. The player 30 will achieve the player loss 48 game result, if the individual result and the community result correspond to: an individual loss and a community tie or community loss; or an individual tie and a community loss. Once the game result has been determined for each player 30, the cooperative card wagering game ends. Note that in certain embodiments, various alternative combinations of community results and individual results may be used to determine the game results in accordance with the principles of the present disclosure.

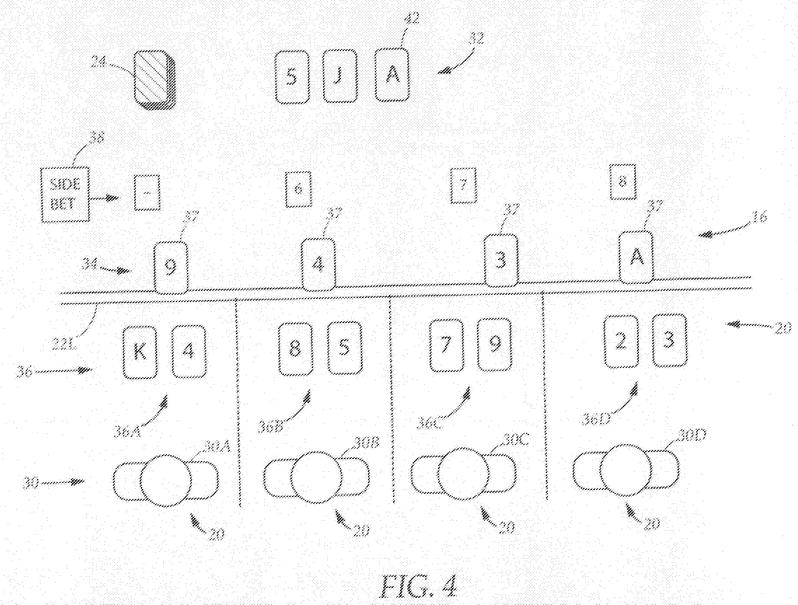

Referring to FIG. 4 while also referring to FIG. 1, in certain embodiments, each player 30 may also place a side bet 38 at the start of the cooperative card wagering game, along with a side wager. The side bet 38 is a prediction by the player 30 of a side outcome within the cooperative card wagering game, to be resolved alongside the game result. As with the wager, the side wager corresponds to chips, tokens, or other representations or currency and/or points. In a preferred embodiment, the side outcome may correspond to the numerical value of the dealer's hand 32, and the player 30 wins the side bet 38 if the player's prediction matches the side outcome. If the side bet 38 does not match the side outcome, the player 30 loses the side bet 38 and forfeits the side wager. However, if the player 30 successfully predicts the side outcome, the player 30 will receive a side bet payout. In certain embodiments, the side wagering area 21B may include a plurality of defined zones, with each zone identifying one of the possible side outcomes. The player 30 places the side wager within the zone which corresponds to the side outcome predicted by the player 30. For example, the side wager area 21B may be divided into ten zones, each corresponding to one of the possible numerical values of the dealer's hand 32.

Referring to FIG. 6B while also referring to FIG. 4, in one embodiment, after the dealer's hand 32 has been revealed but before the community result is determined, an additional dealer card 42 may be added to the dealer's hand 32 to add an element of variability. The total numerical value of the dealer's hand 32 is compared against a draw threshold 42T, and the additional card 42 is added to the dealer's hand 32 if the total numerical value is less than or equal to the draw threshold 42T. In a preferred embodiment, the draw threshold 42T is dependent upon the quantity of players 30 participating in the cooperative card wagering game. Increasing the quantity of participating players 30 will lower the draw threshold 42T and increase the likelihood that the dealer 32 will draw an additional card 42, thus increasing the probability that the total numerical value of the dealer's hand 32 will remain relatively low, making it easier to achieve community or individual wins. For example, the draw threshold 42T may have a value of: eight when there is one player 30, seven when there are two players, six when there are three players, five when there are four players, and four when there are five players or more.

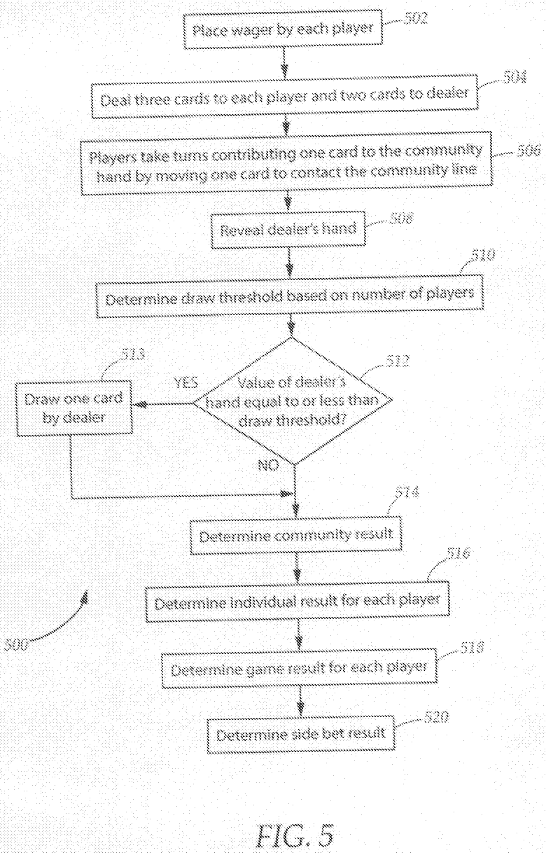

Turning to FIG. 5 and FIG. 4, while also referring to FIG. 1, an example cooperative card wagering game process 500 is shown, and the principles of the cooperative card wagering game will be explained in the context of a sample game with four players 30 as illustrated in FIG. 4. The cooperative card wagering game begins at step 502, and each of the players 30 places a wager. Each of the players 30 may also choose to place a side bet 38. In the present example, Player “A” chooses not to place a side bet 38, while Players “B”, “C”, and “D” each place a side bet 38 which attempts to predict a side outcome corresponding to the total numerical value of the dealer's hand 32. Next, at step 504, the dealer 28 distributes three cards from the deck 24 to each player 30 to create each individual hand 36, and takes two cards from the deck 24 to form the dealer's hand 32. The individual hand 36A of Player “A” 30A contains a face card, a “nine”, and a “four”; the individual hand 36B of Player “B” 30B contains a “four”, a “five”, and an “eight”; the individual hand 36C of Player “C” 30C contains a “three”, a “seven”, and an “nine”; and the individual hand 36D of Player “D” 30D contains an “ace”, a “two”, and a “three”.

At step 506, each player 30 selects one of the cards in the player's individual hand 36 as a community card 37, and contributes the selected community card 37 to the community hand 34. The players “A”, “B”, “C”, and “D” contribute a “nine”, a “four”, a “three”, and an “ace” respectively to the community hand 34, resulting in the community hand 34 having a total numerical value of “seven”. Each player 30 places their selected community card 37 in contact with the community line 22L, simultaneously distinguishing the community card 37 from the cards remaining within the individual hands 36 and providing every player 30 with an unobstructed view of the community cards 37. Once the community hand 34 is complete, the dealer's hand 32 is revealed at step 508. In the present example, the dealer's hand 32 includes a “five” and a face card, for a total numerical value of five. Referring to FIG. 6B while continuing to refer to FIGS. 1, 4, and 5, at step 510, the draw threshold 42T is determined based on the quantity of players 30. As there are four players, the draw threshold corresponds to “five”. Next, at step 512, the total numerical value of the dealer's hand 32 is compared with the draw threshold 42T in order to determine if the dealer 28 will draw an additional dealer card 42. As the total numerical value of the dealer's hand is “five”, which is equal to or less than the draw threshold 42T of “five”, the process proceeds to step 513 and the additional dealer card 42 is added to the dealer's hand 32. In the present example, the additional dealer card 42 is revealed to be an “ace” card. If the total numerical value of the dealer's hand 32 was greater than the draw threshold 42T, the process would instead proceed from step 512 directly to step 514.

At step 514, the total numerical value of the dealer's hand 32 is compared to the total numerical value of the community hand 34 to determine the community result. As the additional dealer card 42 is an “ace” card with a numerical value of “one”, the total numerical value of the dealer's hand 32 is increased to “six”. This is less than the total numerical value of the community hand 34, which is “seven”. The community result is therefore a community win. Next, at step 516, the total numerical value of each individual hand 36 is compared with total numerical value of the dealer's hand 32 to determine the individual result for each player 30. In the present example, player “A” 30A, player “B” 30B, and player “D” 30D each have individual hands 30 which have total numerical values which are less than the total numerical value of the dealer's hand 32, and therefore each of said players obtains an individual loss as the individual result. The total numerical value of the individual hand 36C of player “C” 30C is higher than the total numerical value of the dealer's hand 32, resulting in an individual win as the individual result of said player 30C.

Referring to FIGS. 4, 5, and 6A, once both the community result and the individual results for each player 30 have been determined, the game result is determined for each player 30 at step 518. For Player “A” 30A, Player “B” 30B, and Player “D” 30D, the community win combined with the individual loss produces the player push 46 game result. However, for Player “C” 30C, the community win combined with the individual win produces the player win 44 game result. Player “C” is awarded a payout, and the wagers placed by each player 30 obtaining the player push 46 game result are not forfeited.

At step 520, all side bets 38 are resolved, by comparing the prediction of each side bet 38 with the side outcome, which is the total numerical value of the dealer's hand 32. In the present example, amongst the side bet predictions made by Player “B” 30B, Player “C” 30C, and Player “D” 30D, only the prediction of “six” made by Player “B” matches the total numerical value of the dealer's hand 32 of “six”. Therefore, the side wagers placed by Player “C” and Player “D” are forfeited, while Player B” is awarded a side payout. The side bet therefore provides each player 30 with the opportunity to win currency or points even if the game result is unfavorable to the player 30.

Payouts and side payouts are made in the form of currency or points, and the amount of the payouts and side payouts may be determined using any method employed in wagering games. For example, payouts and side payouts may be increased or decreased in proportion to the likelihood, or odds, of the game result or side outcome occurring. In one example embodiment, the amount of a standard payout may be calculated as a ratio of 1:2 for every point or unit of currency of the wager, but is increased to a ratio of 1:1 if the community and individual results are a community win and individual win respectively.

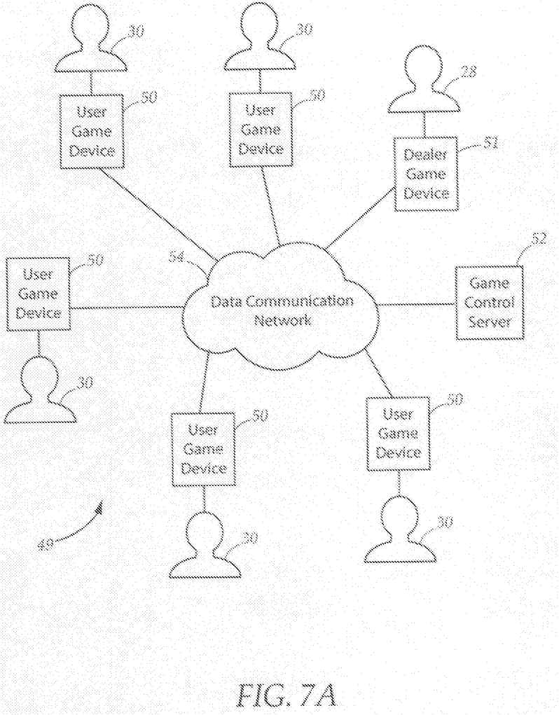

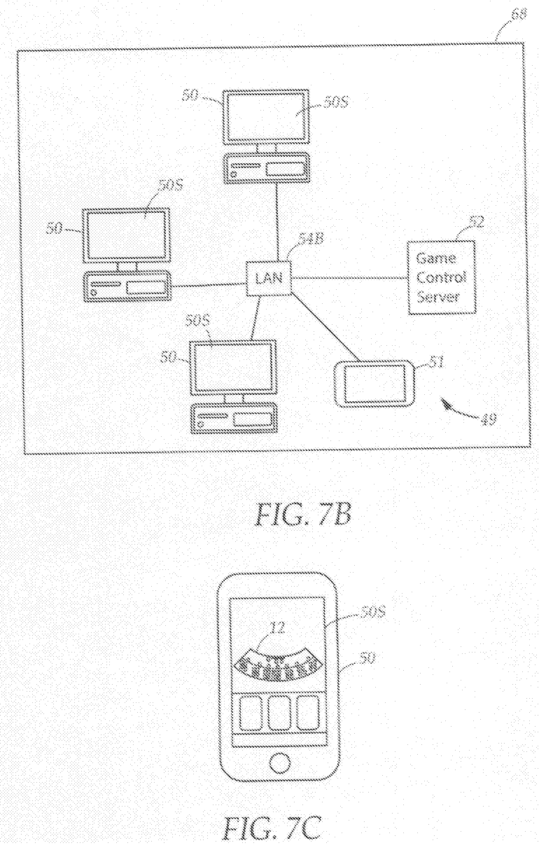

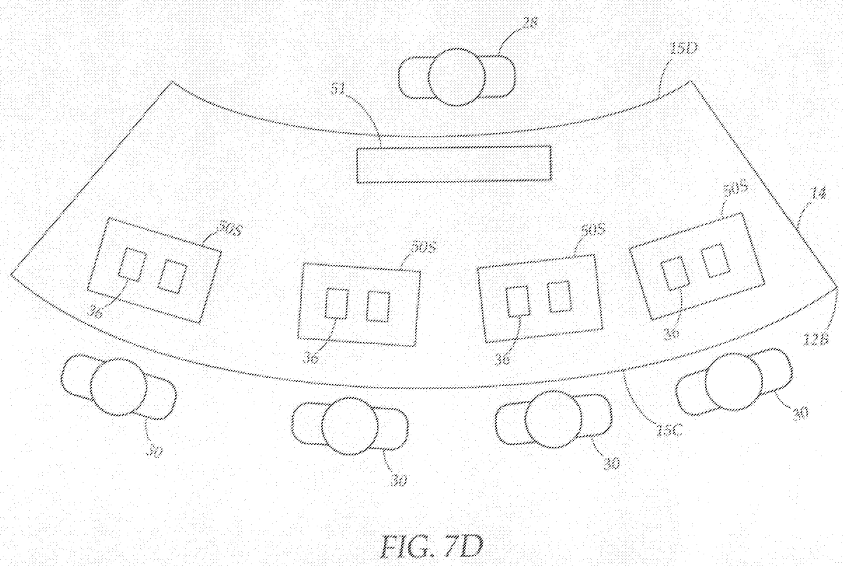

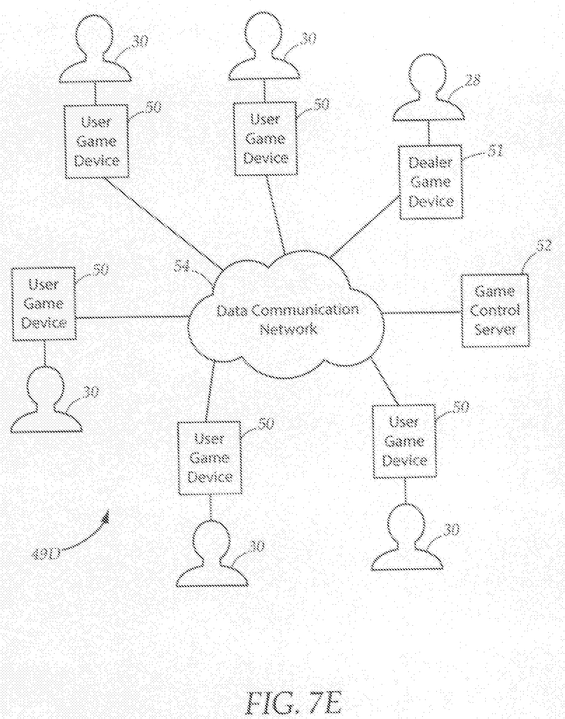

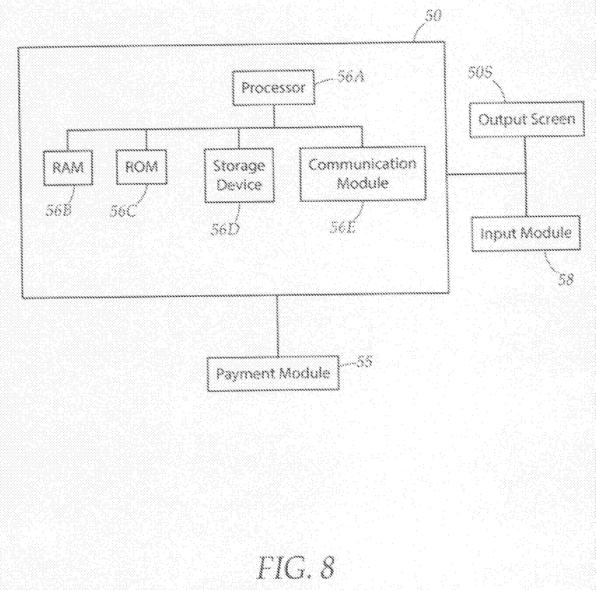

Turning now to FIG. 7A, FIG. 7C, and FIG. 8, the cooperative card wagering game may be played in computerized form using a cooperative card game system 49. In one embodiment, the cooperative card game system 49 comprises a plurality of user game devices 50 and a game control server 52. The user game devices 50 and the game control server 52 are operably connected via a data communication network 54 such as the internet. Each user game device 50 allows one player 30 to access the cooperative card game system 49, and may be implemented using a personal computer, a mobile phone, tablet, laptop, or other suitable computing device. Each user game device 50 is adapted to execute a multiplayer card game application. In one embodiment, the user game device 50 comprises a processor 56A, a RAM 56B, a ROM 56C, and a storage device 56D. The user game device 50 further has an output screen 50S capable of displaying game graphics, an input module 58 such as a touch sensor, controller, or other input device adapted to receive game commands as user inputs, and a communication module 56E adapted to communicate with other user game devices 50 and the game control server 52. In certain embodiments, the cooperative card game system 49 may have a dealer game device 51 which is substantially similar to the user game device 50, which allows a dealer 28 to access the cooperative card game system 49 and perform dealer actions necessary to play the cooperative card wagering game. The game control server 52 is adapted to arbitrate the multiplayer card game application between the various user game devices 50, and may also be adapted to automate the dealer actions in place of a live dealer 28.

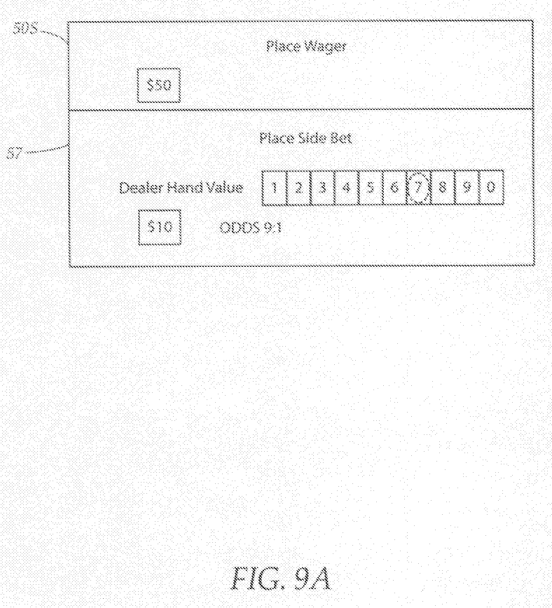

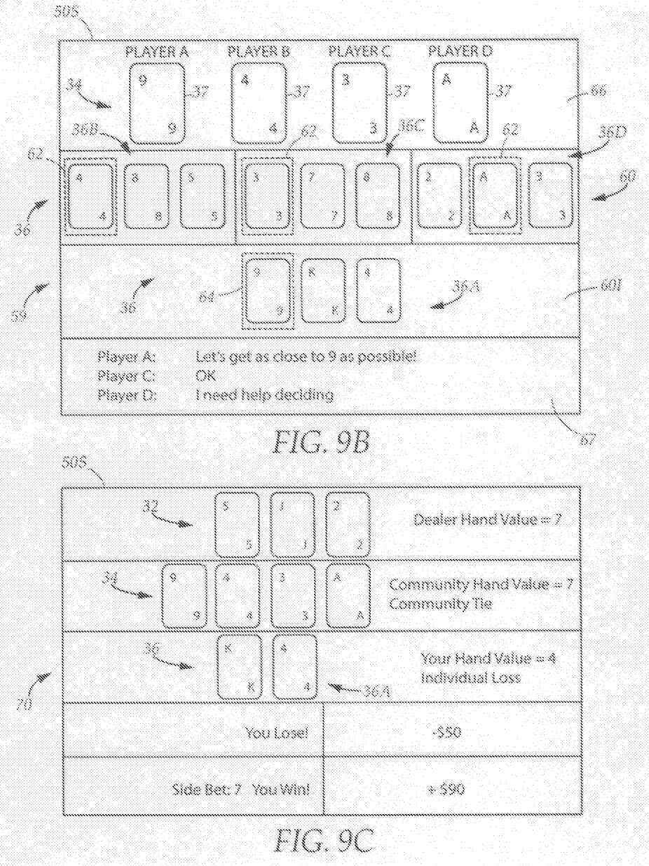

Referring to FIG. 1, FIG. 7A, FIG. 7C, and FIG. 8, the multiplayer card game application substantially replicates the process (as shown in FIG. 5) of playing the cooperative card wagering game, by electronically recreating the card deck 24, and allowing electronic representations of the cards to be dealt to the players 30. The output screen 50S of each user game device 50 may also display a virtual representation of the playing surface 14 of the cooperative wagering table 12, along with graphical depictions of the individual hands 36, the community hand 34, the community line 22L, and the dealer's hand 32. Referring to FIG. 9A and FIG. 7A, the multiplayer card game application may present each player 30 with a wagering interface 57 which allows the player 30 to place wagers and side bets at the start of the cooperative card wagering game.

Referring to FIG. 9B and FIG. 7A, the multiplayer game application may present each player 30 with a cooperative game interface 59 via the output screen 50S, comprising an individual player hand display 601 showing the individual hand 36 of the player associated with the user game device 50, a plurality of player hand previews 60 each showing the individual hands 36 of the other players 30, and a community hand preview 66 which displays the community hand 34. The player hand preview 60 allows each player 30 to make a community card selection 62 of one of the cards in the individual hands 36 of the other players 30, thus sending a recommendation to the other player to contribute the selected card to the community hand 34. The individual player hand display 601 may mark each card recommended by another player 30 as a community card recommendation 64. In the present example, the individual player hand display 601 shows the individual hand 36A of Player “A”, while the player hand preview 60 displays the individual hands 36B, 36C, 36D of Players “B”, “C”, and “D” respectively. To further facilitate cooperation between the players 30, the cooperative game interface 59 may further comprise a chat interface 67 which allows each player to communicate with the other players 30. Communication between the players 30 may be carried out via text chat, as well as by voice or video chat, and the user game device 50 may be configured with the necessary microphone, camera, or other input devices as required. Each player may select one of the cards within the individual player hand display 601 as the community card 37, and the selected community card 37 will be removed from the individual player hand display 601 and be displayed within the community hand preview 66.

Turning to FIG. 9C while also referring to FIG. 7A and FIGS. 9A-B, the multiplayer card game application may be adapted to display a result interface 70 via the output screen 50S of the user game device 50, which summarizes the relevant results. Once the community hand 34 is complete, the multiplayer game application reveals the dealer's hand 32 and draws an additional card if applicable, before proceeding to determine the community result, the individual result and game result for each player, and the outcomes of any side bets as appropriate. In one embodiment, the result interface 70 may display the dealer's hand 32 along with the community hand 34 and the individual hand 36 of the player 30 associated with the user game device 50. In the present example, the result interface 70 indicates that the community result is a community tie, while the individual result and game result for Player “A” is an individual loss, and a player loss respectively. The wager amount of $50 placed by Player “A” is forfeited. However, the side bet prediction of “7” successfully predicted the total numerical value of the dealer's hand, and Player “A” is awarded a side payout of $90, corresponding to the side wager of $10 increased by a defined odds multiplier. All wagers and payouts are deducted from or added to a game balance of either money or points, as appropriate.

Turning to FIG. 7B while also referring to FIG. 8, in an alternative embodiment, the cooperative card game system 49 may be employed within a gaming venue 68, whereby each user game device 50 is implemented as a dedicated card gaming station. Each user game device 50 may also have a payment module 55 for scanning credit cards, or receiving/dispensing tokens, coins, bills, or currency. The user game devices 50 and the game control server 52 may alternatively be operably connected via a local area network 54B or other wireless communication protocol. Referring to FIG. 7D, FIG. 8, and FIG. 1, in certain embodiments, the user game devices 50 may be incorporated into an electronic cooperative wagering table 12B which has a playing surface 14, whereby the user game devices 50 and the dealer game device 51 are disposed within the table 12 such that the output screens 50S are accessible through the playing surface 14. In other embodiments, the electronic cooperative wagering table 12B may contain a single user game device 50 operably configured to one or more of the output screens 50S. In certain embodiments, the features of the playing surfaces 14 of the cooperative wagering table 12, including the arcuate configuration of the dealer and community table edges 15D, 15C and the community line 22L may be replicated using one or more output screens 50S disposed across the playing surface 14 of the electronic cooperative wagering table.

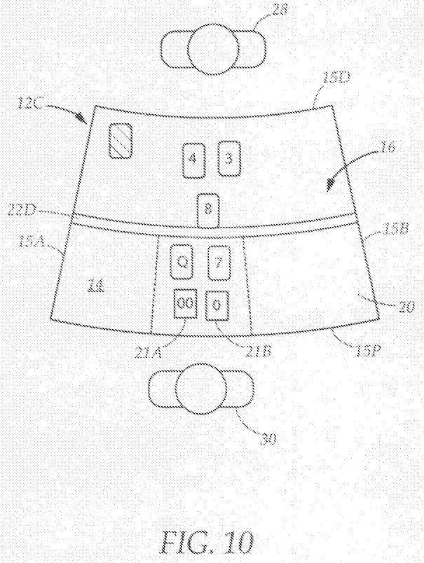

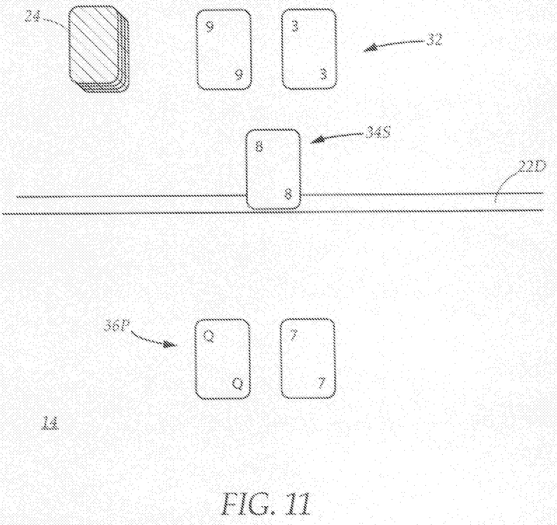

Referring to FIG. 10 and FIG. 11 along with FIG. 1 and FIG. 2A, the cooperative card wagering game may be played in a variant format as a dual-hard card wagering game, whereby the player 30 plays independently against the dealer 28.

The dual-hand card game is played on a wagering table 12C with a playing surface 14, a dealer table edge 15D, and a player table edge 15P. The wagering table 12C may also have a first end 15A and a second end 15B between which the dealer table edge 15D and the player table edge extend 15P. In one embodiment, the wagering table 12C has a dividing line 22D which is positioned between the dealer table edge 15D and the player table edge 15P to divide the playing surface 14 between a dealer area 16 and a player area 20. The dealer 28 and the player 30 may be positioned along the dealer table edge 15D and the player table edge 15P respectively. The playing surface further has a wagering area 21A for the placement of wagers, and a side wager area 21B for the placement of side bets and side wagers. The wagering area 21A and the side wager area 21B may be positioned within the player area 20 or the dealer area 16.

At the start of the dual-hand card wagering game, the player 30 places a wager, which may be placed within the wagering area 21A. The dual-hand card wagering game is similar to the cooperative card wagering game, except that the player 30 does not contribute a card to the community hand 34. Instead the dual-hand card wagering game is played with two hands—a primary hand 36P, and a secondary hand 34S. The player 30 competes against the dealer 28 using both the primary and secondary hands 36P, 34S to achieve a primary result and a secondary result. In turn, the primary result and the secondary result determine an overall game result.

In the dual-hand card wagering game, the player 30 is dealt three cards from the deck 24 which form the primary hand 36P. In one embodiment, the three cards are dealt to the player 30 by placing the cards within the player area 20 by the dealer 28. The dealer 28 retains two cards, which form the dealer's hand 32. The cards comprising the dealer's hand 32 are placed face down in the dealer area 16. Next, the player 30 selects one of the cards from the primary hand 36P and transfers the card to the secondary hand 34S, while retaining two cards in the primary hand 36P. In the present example, the player 30 is dealt three cards corresponding to a an “eight”, a “seven”, and an “queen”. The player 30 selects the “eight” and transfers the card to the secondary hand 34S.

The card of the secondary hand 34S is placed on the playing surface 14 in such a way as to distinguish the secondary hand 34S from the primary hand 36P. In one embodiment, the card of the secondary hand 34S may be placed face-up upon the playing surface 14 in contact with the dividing line 22D. Alternatively, the card of the secondary hand 34S may be placed within the player area 20.

Referring to FIG. 11, after the secondary hand 34S has been placed, the dealer's hand 32 is revealed, and the total numerical value of the dealer's hand 32 is determined. In a preferred embodiment, the total numerical value of each of the dealer's hand 32, the secondary hand 34S, and the primary hand 36P, is calculated in the same manner as the cooperative card wagering game, with each face card having a value of zero, each number card having a value equal to its printed number, and each ace card having a numerical value of one. Where the sum of the numerical values of the cards is greater than nine, only the rightmost digit is retained for the total numerical value of the hand. For example, the dealer's hand 32 may have two number cards comprising a “nine” and a “three”. Only the rightmost digit of the sum of twelve (“12”) is retained, resulting in a total numerical value of two.

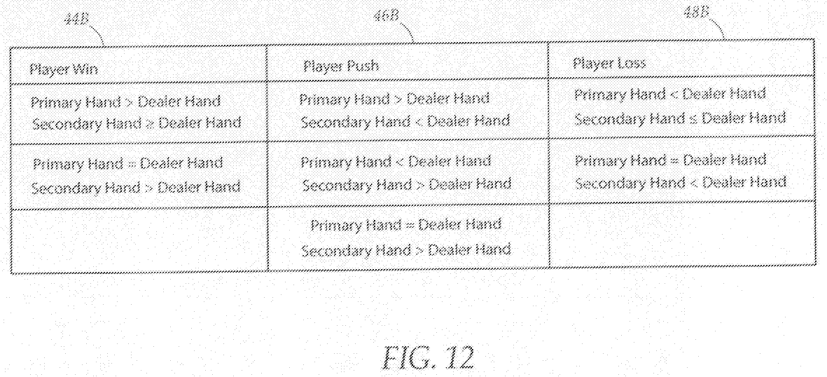

Referring to FIG. 12 alongside FIGS. 10 and 11, once the total numerical value of the dealer's hand 32 has been determined, the dealer's hand 32 is compared against the secondary hand 34S and the primary hand 36P to determine the secondary result and the primary result respectively. The secondary result is a secondary win if the secondary hand 34S exceeds the dealer's hand 32, a secondary tie if the secondary hand 34S equals the dealer's hand 32, and a secondary loss if the secondary hand 34S is less than the dealer's hand 32. Similarly, the primary result is a primary win if the primary hand 36P exceeds the dealer's hand 32, a primary tie if the primary hand 36P equals the dealer's hand 32, and a primary loss if the primary hand 36P is less than the dealer's hand 32.

The overall game result is dependent on the primary result in combination with the secondary result, and may either be a player win 44B, a player push 46B, or a player loss 48B. In a preferred embodiment, the game result will be a player win 44B if the secondary result is a secondary win or a secondary tie and the primary result is a primary win, or if the secondary result is a secondary win and the primary result is a primary tie. The game result will be a player push 46B, if the secondary result is a secondary loss and the primary result is a primary win, if the secondary result is a secondary win and the primary result is a primary loss, or if the secondary result is a secondary tie and the primary result is a primary tie. The game result will be a player loss 48B, if the secondary result is a secondary loss or a secondary tie and the primary result is a primary loss, or if the secondary result is a secondary loss and the primary result is a primary tie.

In order to achieve a player win 44B, the player 30 must carefully allocate the three cards between the primary hand 36P and the secondary hand 34S to achieve a combination most likely to achieve a player win 44B. If the player 30 deems it difficult to achieve high numerical values for both the primary and secondary hands 36P, 34S, the player 30 may seek to maximize either one of the two hands in order to achieve a player push 46B and avoid a player loss 48B.

In the present example, the secondary hand 34S has a total numerical value of eight, while the primary hand 36P has a total numerical value of seven. The dealer's hand 32 has a total numerical value of two, so both the secondary hand 34S and the primary hand 36P exceed the dealer's hand 32, resulting in a secondary result of a secondary win and a primary result of a primary win. The game result is therefore a player win 44B.

If the game result is a player win 44B, the player 30 will be awarded a payout. If the game result is a player loss 48B, the player's wager is forfeited. If the game result is a player push 46B, the wager placed by the player 30 may be returned.

Referring to FIG. 10 and FIG. 1, in certain embodiments, the player 30 may place a side bet and a side wager prior to the cards being dealt, in a manner similar to the side bet of the cooperative card wagering game. The side bet may therefore be a prediction of a side outcome corresponding to the total numerical value of the dealer's hand. The side bet may be resolved at any time during the dual-hand card wagering game after the dealer's hand 32 is revealed. If the side bet accurately predicts the side outcome, the player 30 will be awarded a side payout. However, if the player 30 fails to predict the side outcome, the side wager is forfeited.

As with the cooperative card wagering game, the wager, side wager, payout, and side payout of the dual-hand card wagering game may take the form of currency, points, chips, tokens, or other suitable markers.

Referring to FIG. 10 and FIG. 11, in certain embodiments, the dual-hand card wagering game is played with more than one player 30. Each player 30 is dealt three cards from the deck 24, and all the players 30 compete individually against the dealer's hand 32. Each player 30 places wagers, side wagers, and side bets independently, and each player 30 achieves a separate game result.

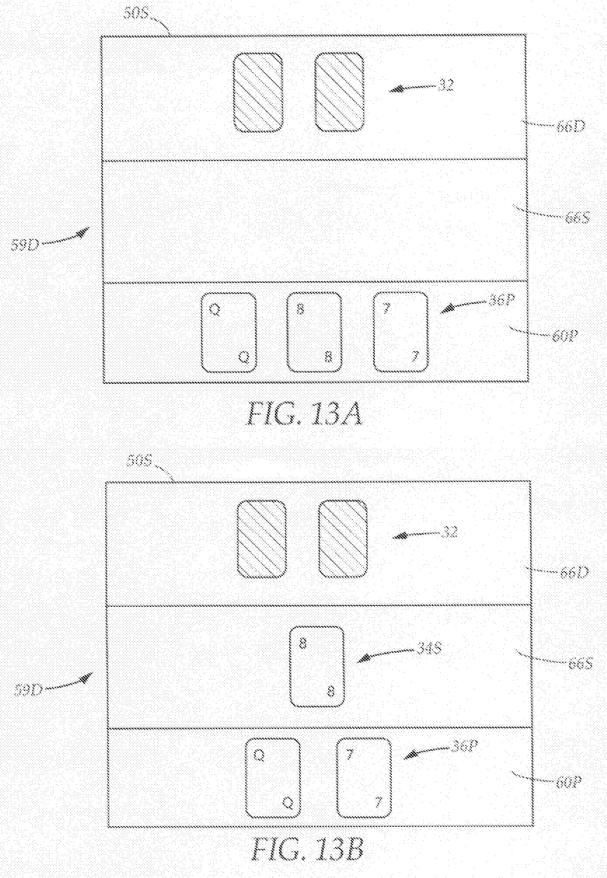

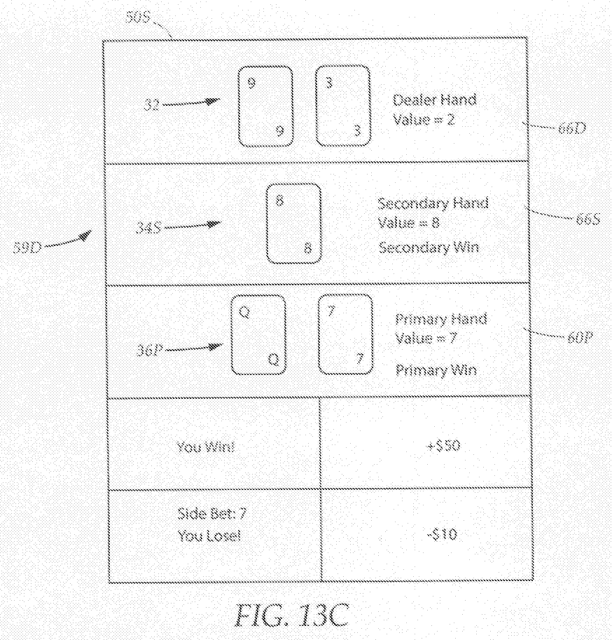

Referring to FIGS. 13A-B and FIG. 7E along with FIGS. 7A-C, the dual-hand card wagering game may also be played in computerized form. In one embodiment, the dual-hand card wagering game may be played using a dual-hand card game system 49D. The dual-hand card game system 49D may be configured in a manner similar to the cooperative card game system 49, and may comprise a game control server 52 and at least one user game device 50 operably connected via a data communication network 54. In certain embodiments, the game control server 52 and the user game device 50 of the cooperative card game system 49 and dual-hand card game system 49D may be implemented using equivalent computing devices. The dual-hand card game system 49D allows one or more players 30 to participate via one or more of the user game devices 50. Each user game device 50 is adapted to receive user inputs which trigger corresponding game commands, such as selecting and transferring cards from the primary hand 36P to the secondary hand 34S, placing wagers, side bets, and side wagers. In certain embodiments, the dual-hand card wagering system 49D may be embodied within a single computing device which performs both the functions of the user game device 50 and the game control server 52, thus allowing the dual-hand card wagering game to be played electronically on a standalone device.

Referring to FIGS. 7B-D along with FIG. 7E, as with the cooperative card game system 49, the dual-hand card game system 49D may be employed within a gaming venue 68. The user game device 50 can be employed in standalone form, or be integrated into a wagering table.

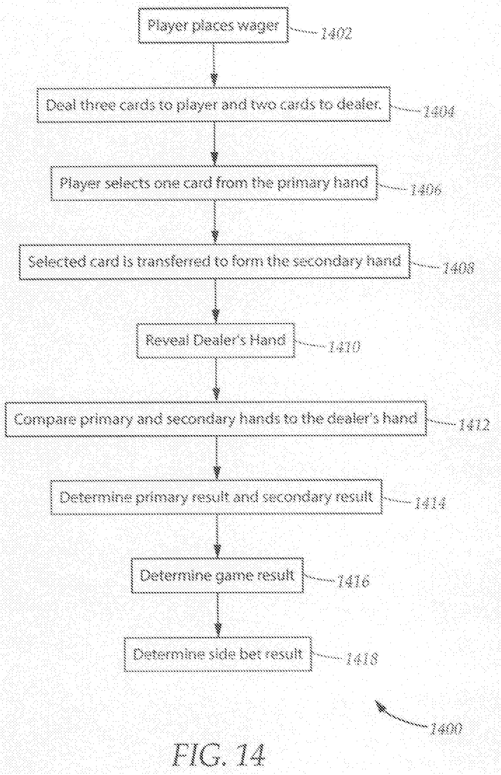

Referring to FIG. 14 while also referring to FIG. 7E, FIGS. 10-11, and FIG. 13A, the user game device 50 and the game control server 52 are adapted to execute a card game application which substantially replicates a dual-hand card wagering game process 1400 which embodies the dual-hand card wagering game as a series of steps. The game control server 52 is adapted to arbitrate the card game application between the various user game devices 50. The card game application also electronically recreates the card deck 24, and provides electronic representations of the cards to be dealt to the player 30. In one embodiment, the card game application is further adapted to automate the actions of the dealer 28, therefore replacing the live dealer 28. In certain alternate embodiments, the dealer 28 may participate as a user, via one of the user game devices 50.

Referring to FIG. 7E, FIG. 13A-B, FIG. 9A, and FIG. 14, in one embodiment, the card game application may present each player 30 with a dual-hand game interface 59D which is displayed via the output screen 50S of the user game device 50. The dual hand gamer interface 59D may have a primary player hand display 60P, a secondary hand display 66S, and a dealer hand display 66D. Each player 30 places a wager at step 1402 of the process 1400. Where multiple players 30 are participating, the card game application allows each player 30 to compete individually against the live or virtual dealer 28.

In one embodiment, the card game application may present a wagering interface 57 to each player 30 via the user game device 50, allowing each player to place a wager, as well as a side bet and a side wager. Next, at step 1404, each player 30 is dealt three cards which form the primary hand 36P, while two cards are used to form the dealer's hand 32. In one embodiment, the cards of the primary hand 36P are shown in the primary player hand display 60P. The dealer's hand 32 is shown within the dealer's hand display 66D, but the cards are displayed face down. At step 1406, each player 30 selects one of the cards within the primary player hand display 60P, and the selected card is transferred to the secondary hand 34S at step 1408, causing the selected card to appear within the secondary hand display 66S. Referring to FIG. 13C, at step 1410, the cards of the dealer's hand 32 are revealed within the dealer hand display 66S. Referring to FIG. 12 while also referring to FIG. 7E, FIG. 13C, and FIG. 14, at step 1412, the primary hand 36P and secondary hand 34S of each player 30 are compared to the dealer's hand 32, and the card game application determines a primary result and a secondary result for each player at step 1414. Next, the card game application determines a game result for each player 30 based on the primary result and secondary result of the player 30.

Each player 30 achieving a player win game result 44B receives a payout, while the wager of each player 30 achieving a player loss game result 48B is forfeited. The wager of each player 30 achieving a player push game result 46B may be returned to the player 30.

At step 1418, any side bets are resolved, and a side payout is awarded to any player 30 who successfully predicted the side outcome and wins the side bet, and the side wager is forfeited for each player 30 who failed to predict the side outcome and loses the side bet.

Note that the dual-hand card wagering game process 1400 is exemplary, and the steps of the process 1400 may be modified, removed, or reordered to implement the gameplay of the dual-hand card wagering game, in adherence with the principles of the present disclosure.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. Other types of languages include XML, XBRL and HTML5. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality and operation of possible implementations of systems, methods and computer program products according to various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flow diagrams depicted herein are just one example. There may be many variations to this diagram or the steps (or operations) described therein without departing from the spirit of the disclosure. For instance, the steps may be performed in a differing order and/or steps may be added, deleted and/or modified. All of these variations are considered a part of the claimed disclosure.

In conclusion, herein is presented systems and methods for playing a cooperative card wagering game and a dual-hand card wagering game variant. The disclosure is illustrated by example in the drawing figures, and throughout the written description. It should be understood that numerous variations are possible, while adhering to the inventive concept. Such variations are contemplated as being a part of the present disclosure.

What is claimed is:

1. A method for playing a dual-hand card wagering game having a player and a dealer, comprising the steps of:
providing a wagering table;
providing a deck comprising a plurality of cards, each card having a numerical value of between zero and nine;
placing a wager by the player;
dealing three cards to the player by the dealer to form a primary hand for the player, retaining two cards by the dealer to form a dealer hand, and hiding the numerical value of each card in the dealer hand;
creating a secondary hand, the player allocating one of the cards from the primary hand to the secondary hand;
revealing the dealer hand;
determining the total numerical value of the dealer hand;
comparing the total numerical value of the dealer hand with the total numerical value of the secondary hand, and determining a secondary result, whereby the secondary result is a secondary win if the secondary hand exceeds the dealer hand, the secondary result is a secondary tie if the secondary hand equals the dealer hand, and the secondary result is a secondary loss if the secondary hand is less than the dealer hand;
comparing the total value of the dealer hand with the total value of the primary hand, and determining a primary result whereby the primary result is a primary win if the primary hand exceeds the dealer hand, the primary result is a primary tie if the primary hand equals the dealer hand, and the primary result is a primary loss if the primary hand is less than the dealer hand;
determining a game result by considering the secondary result in combination with the primary result, obtaining the game result of a player win if the secondary result is a secondary win or a secondary tie and the primary result is a primary win, or if the secondary result is a secondary win and the primary result is a primary tie, obtaining the game result of a player loss if the primary result is a primary loss and the secondary result is a secondary tie or secondary loss, or if the primary result is a primary tie and the secondary result is a secondary loss;
forfeiting the wager upon the player obtaining the player loss game result; and
awarding a payout to the player upon obtaining the player win game result.

2. The method as recited in claim 1, wherein:
the step of placing a wager by the player is followed by the step of placing a side bet and a side wager by the player, the player making a prediction of a side outcome, the side outcome corresponding to the total numerical value of the dealer hand;
the step of determining a game result is followed by the step of winning the side bet upon the player successfully predicting the side outcome, and losing the side bet upon the player failing to predict the side outcome;
the step of forfeiting the wager further comprises forfeiting the side wager upon the player losing the side bet; and
the step of awarding a payout further comprises awarding a side payout upon the player winning the side bet.

3. The method as recited in claim 2, wherein:
the step of determining a game result further comprises obtaining the game result of a player push if the secondary result is a secondary tie and the primary result is a primary tie, if the secondary result is a secondary loss and the primary result is a primary win, or if the secondary result is a secondary win and the primary result is a primary loss; and
the step of awarding a payout is followed by the step of returning the wager upon the player obtaining the player push game result.

4. The method as recited in claim 3, wherein:
the wagering table comprises a playing surface, the playing surface having a dealer table edge, a player table edge, and a dividing line positioned therebetween, the dividing line dividing the playing surface between a dealer area and a player area;
the step of placing a wager by the player is preceded by the step of positioning the player along the player table edge;
the step of dealing three cards to the player further comprises placing the cards of the primary hand of the player within the player area; and
the step of creating a secondary hand further comprises placing the card allocated by the player to the secondary hand in contact with the dividing line, and distinguishing the secondary hand from the cards remaining in the primary hand.

5. The method as recited in claim 1, wherein the step of determining the total numerical value of the dealer hand further comprises determining the total numerical value of each of the dealer hand, the secondary hand, and the primary hand, by adding together the numerical value of each card in the dealer hand, primary hand, or secondary hand, obtaining a sum of at least one digit, and retaining only the rightmost digit of the sum to produce the total numerical value.

6. A method for playing a dual-hand card wagering game having a player, comprising the steps of:
providing a dual-hand card game system comprising a user game device operably connected to a game control server, the user game device is adapted to execute a card game application and has an output screen and an input device, the game control server is adapted to execute dealer functions of drawing and dealing cards;
generating a virtual deck of cards by the card game application, each card within the virtual deck having a numerical value of between zero and nine;
presenting the player with a wagering interface via the output screen of each user game device;
placing a wager by the player using the wagering interface in combination with the input device;
presenting the player with a dual-hand game interface using the output screen of the user gaming device;
dealing three cards to the player by the dealer to form a primary hand for the player, displaying the cards of the primary hand within a primary player hand display within the dual-hand game interface;
dealing two cards to form a dealer hand, and hiding the numerical value of each card in the dealer hand;
selecting one of the cards displayed in the primary player hand display by the player, and removing the selected card from the primary player hand display by the card game application, forming a secondary hand using the selected card and displaying the secondary hand within the dual-hand game interface;
revealing the dealer hand via the output screen of each user game device;
determining the total numerical value of the dealer hand by the card game application;
comparing the total numerical value of the dealer hand with the total numerical value of the secondary hand by the card game application, and determining a secondary result, whereby the secondary result is a secondary win if the secondary hand exceeds the dealer hand, the secondary result is a secondary tie if the secondary hand equals the dealer hand, and the secondary result is a secondary loss if the secondary hand is less than dealer hand;
comparing the total numerical value of the dealer hand with the total numerical value of the primary hand by the card game application, and determining a primary result, whereby the primary result is a primary win if the primary hand exceeds the dealer hand, the primary result is a primary tie if the primary hand equals the dealer's hand, and the primary result is a primary loss if the primary hand is less than the dealer hand;
determining a game result via the card game application by considering the secondary result in combination with the primary result, obtaining the game result of a player win if the secondary result is a secondary win or a secondary tie and the primary result is a primary win, or if the secondary result is a secondary win and the primary result is a primary tie, obtaining the game result of a player loss if the primary result is a primary loss and the secondary result is a secondary tie or secondary loss, or if the primary result is a primary tie and the secondary result is a secondary loss;
displaying the game result using the output screen of each user game device;
forfeiting the wager upon the player obtaining the player loss game result; and
awarding a payout to the player upon obtaining the player win game result.

7. The method as recited in claim 6, wherein:
the step of placing a wager by the player is followed by the step of placing a side bet and a side wager using the wagering interface, making a prediction of a side outcome, the side outcome corresponding to the total numerical value of the dealer hand;
the step of determining a game result is followed by the step of winning the side bet upon the player successfully predicting the side outcome, and losing the side bet upon the player failing to predict the side outcome;
the step of forfeiting the wager further comprises forfeiting the side wager by the player upon losing the side bet; and
the step of awarding a payout further comprises awarding a side payout upon the player winning the side bet.

8. The method as recited in claim 7, wherein:
the step of determining a game result further comprises obtaining the game result of a player push if the secondary result is a secondary tie and the primary result is a primary tie, if the secondary result is a secondary loss and the primary result is a primary win, or if the secondary result is a secondary win and the primary result is a primary loss, and
the step of awarding a payout is followed by the step of returning the wager upon the player obtaining the player push game result.

9. The method as recited in claim 8, wherein:
the step of selecting one of the cards displayed in the primary player hand display further comprises displaying the secondary hand in a secondary hand display within the dual-hand game interface.

10. The method as recited in claim 6, wherein:
the step of determining the total numerical value of the dealer hand further comprises determining the total numerical value of each of the dealer hand, the secondary hand, and the primary hand, by adding together the numerical value of each card in the dealer hand, primary hand, or secondary hand, obtaining a sum of at least one digit, and retaining only the rightmost digit of the sum to produce the total numerical value.
